(19) United States
(12) Patent Application Publication
(10) Pub. No.: US 2025/0197572 A1
(43) Pub. Date: Jun. 19, 2025

(54) SHEET MOLDING COMPOSITION WITH LIMITED DEGASSING

(71) Applicant: Teijin Automotive Technologies, Inc., Auburn Hills, MI (US)

(72) Inventors: David J. Krug, III, Auburn Hills, MI (US); Michael Z. Asuncion, Auburn Hills, MI (US); Amber M. Rossi, Auburn Hills, MI (US); James R. Hutchinson, Auburn Hills, MI (US); Michael J. Hiltunen, Auburn Hills, MI (US); Michael J. Siwajek, Auburn Hills, MI (US)

(73) Assignee: Teijin Automotive Technologies, Inc., Auburn Hills, MI (US)

(21) Appl. No.: 18/836,157

(22) PCT Filed: Jan. 31, 2023
(86) PCT No.: PCT/US2023/011953

§ 371 Date: Aug. 6, 2024

Related U.S. Application Data
(60) Provisional application No. 63/307,650, filed on Feb. 8, 2022.

(51) Int. Cl. C08J 5/04

(52) U.S. Cl. CPC C08J 5/042; C08J 2367/06

(57) ABSTRACT

A low profile additive composition is provide that includes thermoplastic particles and a hydrogen bonding monomer in which the thermoplastic particles are dispersed and forming hydrogen bonding with the thermoplastic particles. The hydrogen bonding monomer has at least two of: a boiling point of greater than 210° C., a viscosity of less 140 cps at 25° C., or vapor pressure lower than 5 mm Hg at 20° C. An article produced therefrom is also provided. A method of forming a low VOC low profile additive composition is also provided.

### CROSS-REFERENCE TO RELATED APPLICATION

This application claims priority benefit to U.S. Provisional Patent Application Ser. No. 63/307,650, filed Feb. 8, 2022, which is incorporated herein by reference.

### FIELD OF THE INVENTION

The present invention in general relates to thermoset molding compounds and methods of forming the same and in particular to a partial replacement of curable monomer that results in reduced degassing that is manifest in reduced article blistering and volatile organic content (VOC) emissions.

### BACKGROUND OF THE INVENTION

Thermoset molding compositions known in the art are generally thermosetting resins containing inorganic fillers and/or fibers. Upon heating, thermoset monomers initially exhibit viscosities low enough to allow for melt processing and molding of an article from the filled monomer composition. Upon further heating, the thermosetting monomers react and cure to form hard resins. At molding temperatures, viscosity reductions often lead to VOC degassing of monomers that contributes to operation complexity and article blistering.

A common industrial use of thermoset compositions is the molding of automotive components. These panels exhibit high dimensional stability and a high gloss molded surface finish required for exposed vehicle surfaces. Automotive components must also have a high degree of dimensional uniformity and stability relative to the preparatory molds so as to maintain the high degree of fit and finish required in modern vehicle manufacturing.

Thermoset compositions based on unsaturated polyester or polyurethane resins and styrene are known to exhibit reduced shrinkage and improved surface properties through the inclusion of inclusions of a low-profile additive (LPA). An LPA is a thermoplastic particle included in the uncured resin to improve the surface finish through shrinkage compensation. Beheshty, M H et al., Iranian Polymer Journal, 15 (2) (2006): 143-153; Dong, J-P, et al. Journal of Applied Polymer Science, 98 (1) (2005): 264-275; and Chan-Park M. B. et al. Polymer Composites, 17 (4) (1986), 537-547. Conventional LPAs illustratively include polyvinylacetates, polystryenes, polyethylenes, polypropylenes, polymethacrylates, and copolymers in which any of the aforementioned represent at least 40 percent of the monomeric subunits of the copolymer. Although known low-profile additives improve the performance of the polyester and polyurethane thermosets, there is a need for compositions exhibiting further improvements, particularly in surface characteristics. A common source of molded article scrappage is surface blistering associated with degassing of unreacted styrene.

Styrene is the most common monomer used in SMC formulations and is regulated by OHSA to limits of approximately of short-term exposure of 600 ppm and for an eight-hour shift to 100 ppm. Other countries have similar regulatory limits. As a result off-gassing of styrene contributes to production costs not only through scrappage associated with blistering but ventilation requirements associated with off-gassing. Styrene has also been implicated as a component of photochemical smog.

Thus, there exists a need for a molding compound composition that retains article dimensional uniformity and stability relative to the preparatory molds yet with reduced VOCs so as to provide a blister-free and otherwise high quality paint finish. There also exists a need for a method for the formation of such a composition.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a bar graph of total VOC and styrene vapor in parts per million for a conventional composition cured SMC and an inventive composition cured SMC, with a more than 4-fold decrease in total VOC and a more than 35-fold decrease in styrene vapor noted in the inventive composition cure SMC;

FIG. 2 is a table that lists rate constants of radical-monomer reactions;

FIG. 3 illustrates reactivity versus crosslink density of various monomers;

FIG. 4 is a bar graph that illustrates that an approximate 40% replacement of divinylbenzene (DVB) in a LPA resulted in a nonlinear reduction of styrene VOCs of 93% in accordance with embodiments of the invention;

FIGS. 5A-5E illustrate comparisons between alternative monomers as shown in FIGS. 5B-5E to styrene in FIG. 5A;

FIG. 6 is a bar graph that illustrates reductions in VOCs in SMC formulations in accordance with embodiments of the invention; and

FIG. 7 illustrates free radical reactions in UPE-styrene SMC.

### SUMMARY OF THE INVENTION

A low profile additive composition is provide that includes thermoplastic particles and a hydrogen bonding monomer in which the thermoplastic particles are dispersed and forming hydrogen bonding with the thermoplastic particles. The hydrogen bonding monomer has at least two of: a boiling point of greater than 210° C., a viscosity of less 140 cps at 25° C., or vapor pressure lower than 5 mm Hg at 20° C. An article produced therefrom is also provided. A method of forming a low VOC low profile additive composition is also provided.

### DESCRIPTION OF THE INVENTION

The present invention has utility as a low-profile additive (LPA) that affords reduced degassing compared to conventional low-profile additives. The inclusion of an inventive low-profile additive in a molding composition such as a styrene monomer-based sheet molding composition (SMC) results in a surprising decrease in VOC degassing from cure articles made therefrom while maintaining dimensional control requirements. Reduced scrappage and ease of manufacture are the manifest improvements of the present invention. Additionally, with the reduced degassing associated with the present invention, cure temperatures can be increased thereby reducing molding cycle times or subsequent processes such as E-coating are possible.

Blisters are essentially a delamination of the cured composite from the off-gassing of compounds that volatilize under the heating conditions above approximately 200° C. Molding composition viscosity is often reduced through addition of reactive diluents. The boiling point of styrene is 145° C. and related aromatic free radical curing C₈₋₁₂ monomers are below the also constitute a source of VOC degassing in molding composition processing.

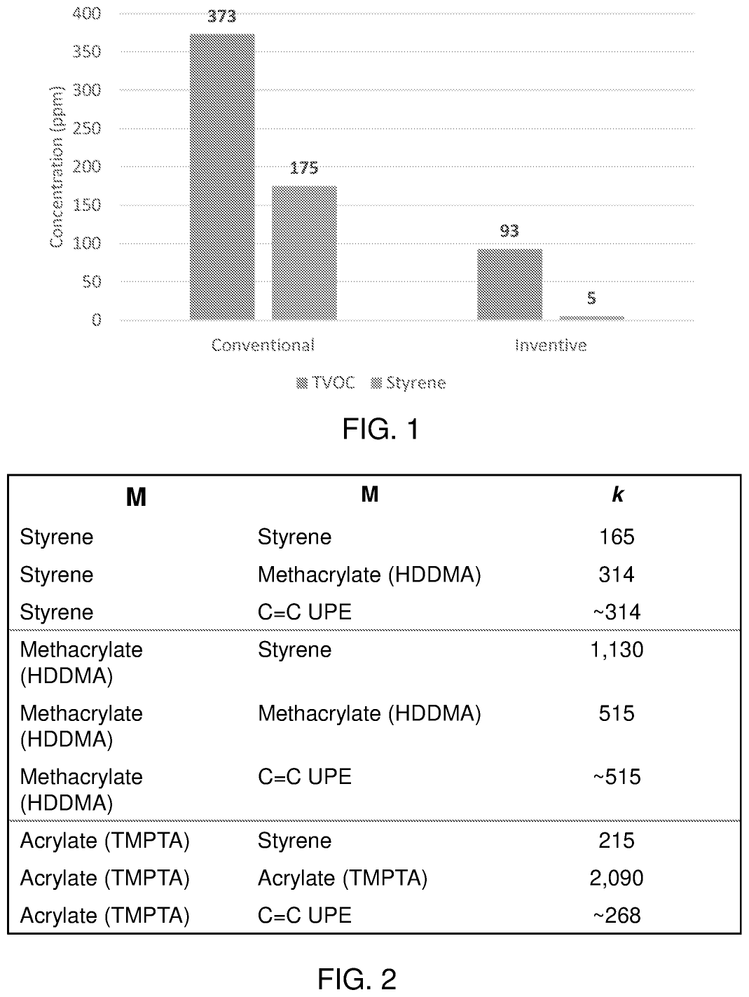

Styrene monomer is the prototypical reactive diluent used to dissolve unsaturated polyester, vinyl ester, thermoplastic low-profile additives, and many other processing aid additives. In some SMC formulations, styrene is the majority component of the organic portion of the matrix. Unreacted styrene in the molded article can be a large source of potential volatiles. Typically, amounts detected by gas chromatograph coupled to mass spectrometer (GC-MS) with a cure conventional SMC sample heated to 90° C. for 30 minutes in accordance with the VDA 278 standard in a thermal desorption chamber have more than 300 parts per million (ppm) total VOCs of which a large percentage is styrene leads to a high occurrence of blisters. This is noted in the left side of FIG. 1. As shown in FIG. 1 a conventional SMC material (855 TCA UltraLite®) has much higher total VOC (TVOC) as compared to the inventive SMC material described herein.

As used herein, a styrenic monomer is one or more of butylstyrene, chlorostyrene, methyl styrene, n-butyl styrene, styrene, or vinyl styrene.

One approach to minimizing residual VOC and in particular styrenic monomer is the industrially impractical extension of dwell time in the mold or a post cure bake. These solutions are not viable due to increased energy consumption, decreased throughput, increased cost, and the requirement of additional capital equipment. Increasing molding temperatures can be counterproductive because it can lead to more rapid volatilization of styrenic monomers rather than polymerization, thereby leading to blistering during molding.

Furthermore, the minimization of VOCs is a critical factor in preventing blistering. In some inventive embodiments, the total VOC content is less than 250 ppm (μg/g) in a cured inventive article, based on a standard calibration curve (toluene equivalents) while still retaining molded article properties and the molding resin handling properties of conventional thermoset SMC resins. Typical thickness of a molded article according to the present invention is between 0.8 and 10 mm. In some inventive embodiments, the inventive fiber reinforced thermoset SMC formulations are compression moldable with short cycle times with SMC resins that cure at temperatures of between 140-160° C. and have the ability to flow and mold complex shapes.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3,2-4, 3-4, and 1-4.

The typical length of the chopped fibers according to the present invention is between 10 and 50 mm.

Some inventive embodiments of the carbon fiber based molding formulation are also amenable to receiving a highly uniform paint or coating. A low density molding compound formulation having a specific gravity of less than 1.65 and in some inventive embodiments, as low as 0.89 is provided that includes a thermoset cross-linkable unsaturated polyester, a low profile additive package containing a maleic anhydride copolymer, hollow microspheroids, and an amount of between 0.1 and 55 weight percent of reinforcing fibers. Reinforcing fibers operative herein include, glass, carbon, polyaramind, natural fibers, and combinations thereof. The reinforcing fibers are dispersed in at least one of the unsaturated polyester and the low profile additive to produce a cured article.

A process for producing such a molding compound panel includes dispersing a low profile additive (LPA) package in an acrylate solvent to displace styrene and hydrogen bond with a thermoplastic component of the LPA, to produce an acrylate modified LPA, The acrylate modified LPA is then dispersed with reinforcing fibers in the molding formulation and curing the thermoset components in the shape of a desired article through contact with a mold platen. The volatile styrene content of the cured article is observed to decrease by at least an order of magnitude compared to a like article formed from with conventional LPA. In some inventive embodiments, the complete, uncured formulation flows having a molding viscosity. Viscosities of between 10 and 50 million Centipoise are especially desirous to promote handling in a production setting.

Inventive formulations for the production of an inventive article amenable to e-coating without surface blistering is provided in Table 1.

TABLE 1
Typical and preferred ranges of components in an inventive
formulation, in which values are provided in total
weight percentages including carbon fiber.

| | Typical Total | Preferred Total |
|---|---|---|
| | Weight Percent | Weight Percent |
| Reactants | | |
| Cross-linkable unsaturated | 5-remainder | 6-remainder |
| polyester and/or vinylester resin | | |
| Ethylenically unsaturated monomer | 4-50 | 6-30 |
| (e.g. styrene) | | |
| Reaction Kinetic Modifiers | | |
| Free radical initiation (e.g. peroxide/ | 0-3 | 0.1-1 |
| peroxy ketals, or azo compounds) | | |
| Polymerization inhibitor (e.g., | 0-2 | 0.1-1 |
| hydroquinone) | | |
| Additives | | |
| Mold release (e.g., stearate additive) | 0-5 | 0.2-3 |
| Plasticizer | 0-3 | 0.1-0.5 |
| Thickeners | 0-5 | 0.5-3 |
| Colorants | 0-3 | 0.1-1 |
| Flame retardant | 0-3 | 0.1-0.7 |
| Thickeners | 0-5 | 0.5-2.5 |
| Colorants | 0-3 | 0.1-1 |
| Fillers | | |
| Particulate filler (e.g., calcium | 0-25 | 1-15 |
| carbonate or alumina) | | |
| Glass microspheroids | 0-15 | 0-10 |
| Chopped carbon fiber bundles | 30-70 | 45-65 |
| Acrylate modified LPA Package | 5-40 | 7-20 |

A variety of base SMC formulations are known such as those described in U.S. Pat. Nos. 4,260,538; 4,643,126; 5,100,935; 5,268,400; 5,854,317; 6,001,919; and 6,780,923; and all of these formulations benefit from the inventive process of acrylate modified LPA dispersion to reduce VOC content and in particular styrene volatility in a resulting cured article formed therefrom. The resulting article is less prone to blistering. The typical amounts of components in an inventive composition are provided in Table 1.

A principal component of a mold compound formulation is an unsaturated polyester resin cross-linkable polymer resin. The prepolymer polymeric resin has a molecular weight on average of typically between 400 and 100,000 Daltons. The polyester prepolymer resins typically represent condensation products derived from the condensation of unsaturated dibasic acids and/or anhydrides with polyols. It is appreciated that the saturated di- or poly-acids are also part of the condensation process to form polyester prepolymers with a lesser equivalency of reactive ethylenic unsaturation sites. Unsaturated polyester resins disclosed in U.S. Pat. No. 6,780,923 are preferred for use with the present invention.

As used herein, “unsaturated” refers to covalent bond attachment to the carbon atoms of a carbon-carbon bond being less than a maximal complement of bonding carbon or hydrogen atoms, namely the carbon-carbon bond is a double or triple bond.

The polymeric resin prepolymer is suspended, and preferably dissolved, in an ethylenically unsaturated monomer that copolymerizes with the resin during the thermoset process. It is appreciated that more than one type of monomer can be used in a molding compound. The monomer provides benefits including lower prepolymer viscosity and thermosetting without formation of a volatile byproduct. Ethylenically unsaturated monomer operative herein illustratively includes styrene, alpha-methylstyrene, vinyltoluene, and chlorostyrene. Styrene is the most commonly used monomer in the formation of SMCs.

A typical molding compound includes a free radical initiator to initiate cross-linking between the polymeric prepolymer resin with itself or with ethylenically unsaturated monomer if present. A free radical initiator is typically chosen to preclude significant cross-linking at lower temperature so as to control the thermoset conditions. Conventional free radical polymerization initiators contain either a peroxide or azo group. Peroxides operative herein illustratively include benzoyl peroxide, cyclohexanone peroxide, ditertiary butyl peroxide, dicumyl peroxide, tertiary butyl perbenzoate and 1,1-bis(t-butyl peroxy) 3,3,5-trimethylcyclohexane. Azo species operative herein illustratively include azobisisobutyronitrile and t-butylazoisobutyronitrile. While the quantity of free radical polymerization initiator present varies with factors such as desired thermoset temperature and decomposition thermodynamics, an initiator is typically present from 0.1 to 3 total weight percent. In order to lessen cross-linking at temperatures below the desired thermoset temperature, a polymerization inhibitor is often included in base molding formulations. Hydroquinone and t-butyl catechol are conventional inhibitors. An inhibitor is typically present between 0 and 1 total weight percent. Collectively, a polymerization initiator and a polymerization inhibitor, to the extent these are present are selected to contribute less than 100 ppm of decomposition products with a boiling point of between 50-250° C.

The inventive molding compound in some inventive embodiments includes a nonconductive particulate filler. Non-conductive particulate fillers operative in such molding compounds illustratively include hollow glass microspheroids, calcium carbonate, calcium silicate, alumina, alumina trihydrate (ATH), silica, talcs, dolomite, vermiculite, diatomaceous earth, kaolin clay, and combinations thereof. Factors relevant in the choice of a particulate filler illustratively include filler cost, resultant viscosity of flow properties, resultant shrinkage, surface finish weight, flammability, and chemical resistance of the thermoset formulation. Typical filler sizes are from 0.1 to 50 microns. It is appreciated that glass microspheres are preferable surface derivatized in applications where high performance is required. Surface derivatized microspheroids are detailed in U.S. Pat. Nos. 7,700,670; and 9,868,829.

In some inventive embodiments, the surface activating agent molecules covalently bonded to the microspheroid surface have a terminal reactive moiety adapted to bond to a surrounding resin matrix during cure. Without intending to be bound to a particular theory, covalent bonding between a cured resin matrix and the microspheroid increases the delamination strength of the resulting SMC in tests such as ASTM D3359. As used herein, the weight percent of a microspheroid covalently bonded to a surface activating agent is intended to include the weight of the surface activating agent.

A terminal reactive moiety that is reactive with an SMC resin during cure illustratively includes a tertiary amine-; hydroxyl-; imine-; an ethylenic unsaturation, such as an allyl- or acryl-; or cyano-moiety. It is appreciated that matrix cure can occur through mechanisms such as free radical cure, moisture cure, and combinations thereof.

Tertiary amine terminated thermoplastic are readily prepared. D. H. Richards, D. M. Service, and M. J. Stewart, Br. Polym. J. 16, 117 (1984). A representative tertiary amine terminated thermoplastic is commercially available under the trade name ATBN 1300 X 21 from Noveon.

A surface activating agent molecule that bonds to a glass microspheroid is an alkoxysilane where the silane is reactive with the silica surface of the microspheroid. Representative alkoxysilane surface activating agents for the microspheroid illustratively include: 3aminopropyltrimethoxysilane, 3-aminopropyltriethoxysilane, 3-glycidoxypropyltrimethoxysilane, 3-glycidoxypropyltriethoxysilane, (3-glycidoxypropyl)bis(trimethylsiloxy) methylsilane, (3-glycidoxypropyl)methyldiethoxysilane, (3-glycidoxypropyl)dimethylethoxysilane, (3-glycidoxypropyl)methyldimethoxysilane, methacryloxymethyltriethoxysilane, methacryloxymethyltrimethoxysilane, methacryloxypropyldimethylmethoxysilane, methacryloxypropyldimethylethoxysilane, methacryloxypropyltrimethoxysilane ethacryloxypropylmethyldimethoxysilane, methacryloxypropyltriethoxysilane, methoxymethyltrimethylsilane, 3-methoxypropyltrimethoxysilane, 3-methacryloxypropyldimethylchlorosilane, methacryloxypropylmethyldichlorosilane, methacryloxypropyltrichlorosilane, 3-isocyanatopropyldimethylchlorosilane, 3-isocyanatopropyltriethoxysilane, bis(3triethoxysilylpropyl) tetrasulfide-, and combinations thereof. In certain inventive embodiments, the alkoxysilane surface activating agent includes an ethylenically unsaturated moiety that is reactive under free radical cross-linking conditions so as to covalently bond the microspheroid surface to the surrounding resin matrix.

Alternatively, it is appreciated that microspheroid surface activating agent is readily mixed into the pre-cured SMC formulation and hollow glass microspheres added thereto to induce microsphere activation prior to initiation of matrix cure. Typically, the surface activating agent is present in concentrations of about 0.05 to 0.5 grams of surface activating agent per gram of microspheroids.

A mold release agent is typically provided to promote mold release. Mold releases include fatty acid salts illustratively including oleates-, palmitates-, stearates-of metal ions such as sodium, zinc, calcium, magnesium, and lithium. A mold release is typically present from 0 to 5 total weight percent.

The low profile additive is provided to improve surface properties and dimensional stability of a resulting molded product. To achieve a reduction in overall VOCs and styrene volatiles in particular in a cured article, the low profile additive package includes thermoplastics that are capable of hydrogen bonding with an acrylate monomer. While it is appreciated that most conventional low profile additives are blends or mixtures of several thermoplastic polymers that are dissolved or dispersed in monomers such as styrene, a low profile additive operative in the present invention includes at least 10 percent by weight of total thermoplastics in the low profile additive package of at least one of polyacrylates, phenolic resin, phenoxy resin, poly(vinylphenol), polyamide, polyethylene glycol, polymethylmethacrylate, polyvinylacetate, polycarbonate, polystyrene, polyethylene terephthalate, polybutylene terephthalate, saturated polyester, polyol, or combinations thereof; and copolymers including butadiene, acrylonitrile, and vinyl chloride and specifically include styrene butadiene rubbers, or combinations thereof. In still other embodiments, the hydrogen bonding thermoplastic is present from 5 to 100 percent by weight of total thermoplastics in the low profile additive package.

A hydrogen bonding monomer operative in the present invention has the attribute of hydrogen bonding with a thermoplastic component of the low profile additive. A hydrogen bonding monomer is selected and meets at least two of the following criteria: a boiling point of greater than 210° C., a viscosity of less 140 cps at 25° C. and ideally less than 10 cps at 25° C., and vapor pressure lower than 5 mm Hg at 20° C. Hydrogen bonding monomers operative in the present invention illustratively include mono-acrylates such as benzyl acrylate, isobornyl acrylate, 4-tert-butylcycolhexyl acrylate, lauryl acrylate, tridecyl acrylate, tetradecyl acrylate, 2-ethylhexyl acrylate, 2-hydroxyl ethylacrylate, 3-hydroxyl propylacrylate, butyl acrylate, C₁-C₁₆ alkylacrylate, C₁-C₁₆ hydroxyl alkylacrylates, C₁-C₁₆ primary amine acrylates, C₁-C₁₆ secondary amine acrylates, cyclohexyl acrylate, ethyl acrylate, ethylacrylate, ethylhexyl acrylates, hexyl acrylate, 2-hydroxyethyl acrylate, 2-hydroxypropyl acrylate, 2-hydroxybutyl acrylate, 3-hydroxypropyl acrylate, 4-hydroxybutyl acrylate, 3-hydroxypentyl acrylate, 6-hydroxynonyl acrylate, or combinations thereof; diacrylates such as 1,6 hexanediol diacrylate, tripropylene glycol diacrylate, dipropylene, glycol diacrylate, triethylene glycol diacrylate, tetraethylene glycol diacrylate, polyethylene glycol diacrylate (PEG repeat units of 120-900), or combinations thereof; triacrylates such as trimethylolpropane triacrylate; mono-methylacrylates such as polypropylene glycol monomethacrylate, benzyl methacrylate, phenoxyethyl methacrylate, tetrahydrofurfuryl methacrylate, lauryl methacrylate, tridecyl methacrylate, tetradecyl methacrylate, methyl methacrylic acid, or combinations thereof; ddimethylacrylates such as 1,4 butanediol dimethacrylate, 1,6 hexandiol dimethacrylate, ethylene glycol dimethacrylate, diethylene glycol dimethacrylate, triethylene glycol dimethacrylate, 1,3 butylene glycol dimethacrylate, polyethylene glycol dimethacylate (PEG repeat units of 120-900), or combinations thereof; dtrimethylacrylates such as trimethylolpropane trimethacrylate; other suitable monomers include N-vinyl-2-pyrrolidone, 1-vinyl-2-pyrrolidone, N-hydroxymethyl acrylamide, N-hydroxymethyl methacrylamide, acrylonitrile, fumarate esters, maleate esters, methacrylonitrile, monomethacryloyloxyethyl phthalate, vinyl acetate, vinylidene chloride, N-hydroxymethyl acrylamide, N-hydroxymethyl methacrylamide, acrylamide, methacrylamide, 2-acrylamido-2-methyl propane Sulfonic acid, acrylic acid, methacrylic acid, C₁-C₁₆ acrylosulfonic acids, itaconic acid; and combinations of any of the aforementioned.

Not intending to be limited to a specific theory, it has been observed that the increased reactivity of methacrylate and acrylate over vinyl as methacrylate/acrylate monomer alternatives act as a scavenger for styrene that provides a reduction in VOC. FIG. 2 illustrates a table of rate constants of radical-monomer reactions, where the rate constant is given by equation 1 as follows:

$$Rp = k [ M \cdot ] [ M ] \qquad ( EQ . 1 )$$

Where k is the propagation rate, M is a momomer, and M· is a momomer radical. As can be seen methacrylate is a more reactive monomer/monomer radical than styrene. The HDDMA radical reacts very quickly with styrene monomer (styrene scavenger).

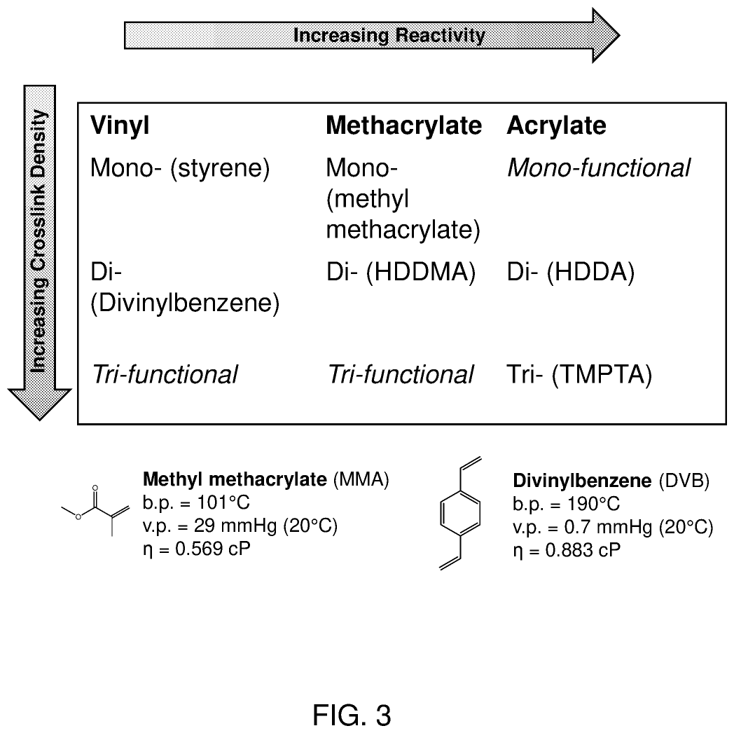

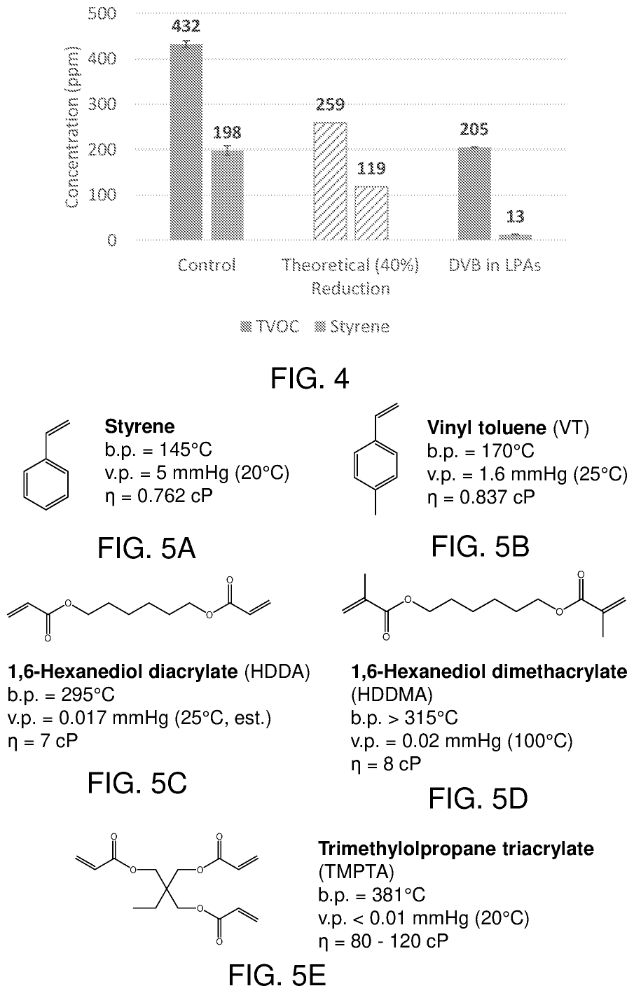

It has further been observed that the reduction in VOC levels in embodiments of the invention may be due to the increase in crosslink density. The increase in crosslink density is because divinylbenzene has essentially the same polarity (and hydrogen bonding) as styrene, and leads to a significant drop in styrene level as shown in FIG. 3. An increase in crosslink density may create a more tortuous path for eluting small molecules. As shown in the bar graph of FIG. 4, an approximate 40% replacement of divinylbenzene (DVB) in a LPA resulted in a nonlinear reduction of styrene VOCs of 93%.

Without intending to be limited to a particular theory, it is believed that the hydrogen bonding monomer displaces styrene within voids of a thermoplastic polymer particle in the low profile additive package. Based on the hydrogen bonding, styrene is displaced from intimate contact with certain hydrogen bonding thermoplastics by the hydrogen bonding monomer thereby reducing the amount of styrene monomer that is unreacted during cure and therefore is available for post cure volatilization. Owing the factors used in selection of the hydrogen bonding monomers, even if a like amount of the hydrogen bonding monomer remains uncured relative to styrene in conventional low profile additive packages, the hydrogen bonding monomer does not contribute to styrene VOC content of the resulting cured article and is less likely to be volatile.

To create an article according to the present invention, a low profile additive package is created with replacement of at least a portion of stryenic monomer by the hydrogen bonding monomer in a conventional low profile additive inclusive of a hydrogen bonding thermoplastic component. This is accomplished by simply adding hydrogen bonding monomer to a conventional low profile additive package based on a styrenic monomer and allowing sufficient time for displacement of the styrenic monomer by the hydrogen bonding monomer.

In specific inventive embodiments, instead of dissolving the thermoplastic beads in styrene, thermoplastic beads were dissolved in an alternative monomer. It would also be possible to have a blend of styrene and alternative monomer for easier dissolution. In some cases higher heat needs to be applied to get the thermoplastic beads to dissolve in the alternative monomers. For example, the maximum temperature currently used to dissolve styrene beads is about 45-50° C. and some of the alternative monomers tried required 90-100° C. In some inventive embodiments, a conventional low profile additive package is dialyzed relative to a bath of hydrogen bonding monomer to achieve a monomer exchange.

An ideal alternative monomer has a high boiling point, low vapor pressure, a viscosity similar to styrene, and a high reactivity. FIGS. 5A-5E illustrate comparisons between alternative monomers as shown in FIGS. 5B-5E to styrene in FIG. 5A. The selection of alternative monomers when unreacted are undectable by GC-MS according to VDA 278 testing conditions: VOC 90° C./30 min, FOG (SVOC) 120° C./60 min.

Traditional SMCs compounded with styrene as the reactive diluent have a noticeable and unpleasant odor. This is primarily due to the amount, volatility, and odor of styrene. This is well known to those who compound or mold SMC in a manufacturing plant. It has been observed that SMC formulated with alternative monomers have considerably less and in some cases no perceivable odor. This is accomplished through the reduction and replacement of styrene with less volatile and lower odor threshold monomers as well as the more complete conversion of styrene as described previously.

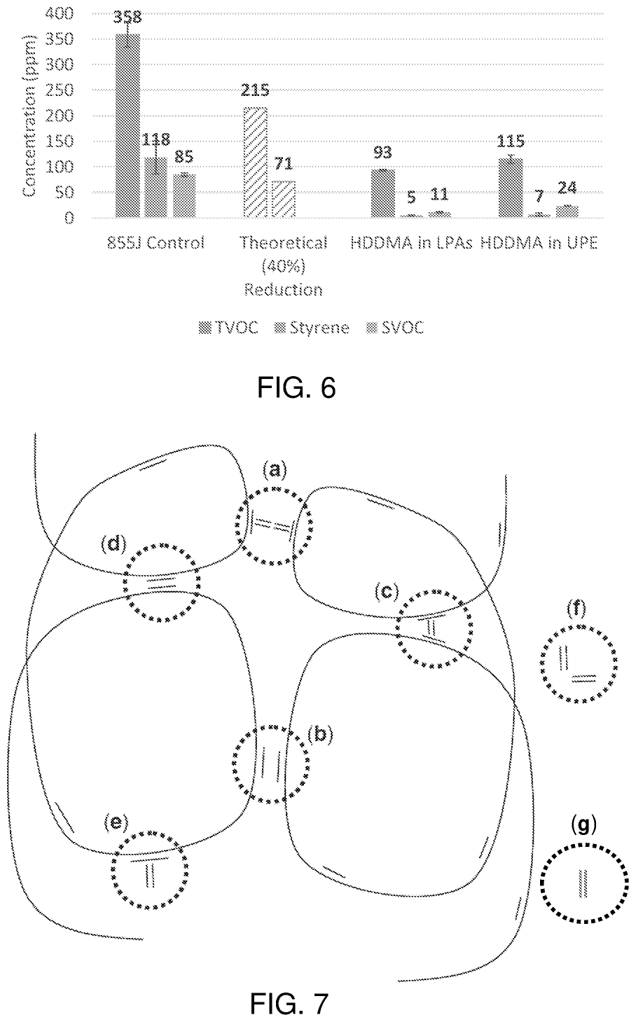

In production the thermoplastic may be received from suppliers as raw beads that are then dissolved in styrene. Alternatively, beads may already be dissolved in styrene from the resin supplier. In one particular case, saturated polyester LPA, already dissolved in styrene because the saturated polyester is a very viscous liquid and not a solid. Therefore, for the LPA work related to this patent beads were dissolved directly into the alternative monomer without any styrene (although a blend is also possible) and saturated polyester LPA was not tried. However, in order to investigate whether the alternative monomer had to come into the “system” with the LPAs or not a solvent exchange was conducted. The solvent exchange was simulated by using a rotary evaporater (and a 40 wt % replacement of styrene with the alternative monomer) with the UPE thermoset (very viscous liquid bought already dissolved in styrene from the resin supplier) and the final results were similar to received raw beads that are then dissolved in styrene as shown in FIG. 6, which seems to indicate that everything gets intimately mixed by the paste mixer and the alternative monomer could be introduced into the paste by multiple pathways. As previously noted above, an approximate 40% replacement of styrene with HDDMA resulted in a nonlinear reduction of styrene and VOCs of over 95%.

FIG. 7 illustrates free radical reactions in UPE-styrene SMC. As shown in FIG. 7 possible reactions during the cure of UPE resin are:
(a) Intermolecular reaction with styrene linking and (b) without
(c) Intramolecular reaction with styrene linking and (d) without
(e) Styrene branching
(f) Styrene-styrene homopolymerization
(g) Unreacted free styrene that is detected as a VOC
   In order to minimize VOCs due to unreacted free styrene (g) the other reactions (a-f) need to be maximized.

In some inventive embodiments, a thixotrope, or thickener is added to adjust for changes in viscosity associated with the inclusion of the hydrogen bonding monomer. It is appreciated that a novel low profile additive is also readily formed that includes hydrogen bonding thermoplastic component that is initially dissolved or dispersed in the hydrogen bonding monomer. Regardless of the preparation techniques once an inventive low profile additive package is formed, it is used in SMC compounding in a manner similar to a conventional low profile additive package.

Hydrogen bonding between a hydrogen bonding monomer and a thermoplastic polymer component of a low profile additive package is readily detected by IR Spectroscopy based on the techniques detailed in Shiao-Wei Kuo, J Polym Res 15 (2008): 459-486.

It is appreciated that the present invention optionally also incorporates additional additives illustratively including flame retardants, plasticizers, colorants, and other processing additives conventional to the art.

For molding compounds of the present invention to be well suited for the rapid production of molded composite articles that have a high gloss finish as measured by ASTM D523 and with a reduced likelihood of surface blistering.

The present invention is particularly well suited for the production of a variety of vehicle panel products illustratively including bumper beams, fenders, vehicle door panel components, automotive floor components, spoilers, hoods, and engine cradles; and various industrial and consumer product housings.

The present invention is further detailed with respect to the following non-limiting examples. These examples are not intended to limit the scope of the appended claims.

### EXAMPLES

### Comparative Example A

A formulation that includes unsaturated polyester cross-linked with styrene, low profile additive package based on combinations of saturated polyester, polymethyl methacrylate, polyvinyl acetate, styrene-butadiene rubber, and suspend in styrene, and thickened by a metal oxide. The final SMC sheet can contain between 5 and 35 wt % monomer. In specific inventive embodiments, low density Class A formulation is based on an unsaturated polyester and does not have an interpenetrating polymer network for thickening. Traditional thickening is with metal oxide. Class A is associated with high quality surface finishes, such as in the auto industry that are characterized by a high surface sheen, and are generally obtained only with highly tailored resin formulations. Class A surfaces are generally required for vehicle surface panels: doors, hoods, quarter panels, trunks, roof structures, bumpers, etc. The formulation has a combination of LPAs. The range of monomer is 10-20 wt % of the full SMC sheet. An SMC plaque having dimensions of 30×30 mm is cured from the formulation under conventional compression molding conditions such as 140-155° C. for 1-3 minutes.

### Example 1

The comparative example A formulation is modified to include a low profile additive is used inclusive of the same thermoplastics are suspended in 1,6 hexanediol dimethacrylate in place of the styrene. The LPA used in the example A is formed with thermoplastic beads, pellets, flakes, powder, chips, etc., and are dissolved in the alternative monomer by low or high shear mixing with or without the application of heat up to 100° C. at concentrations similar to conventional styrene based LPAs. As a result, the amount of styrene in the formulation is reduced by 40 weight percent relative to the comparative Example A. An SMC plaque is formed under like conditions as to that of comparative Example A.

### Example 2

A VOC analysis method is performed in which the plaques of comparative Example A and Example 1 are heated according to the standardized VDA 278 test method in which thermal desorption from the molded SMC plaque occurs at 90° C. for 30 minutes. Volatiles are trapped, thermally desorbed, and injected into a GC/MS for analysis. Concentrations are given in ppm (μg/g) based on a standard calibration curve (toluene equivalents). The results are summarized in the FIGS. and show the comparative Example A plaque has a total VOC (TVOC) of 373 ppm and a styrene desorption of 175 ppm, while the corresponding values for the inventive plaque of Example 1 are 93 and 5 ppm, respectively. A greater than 30 times decrease in styrene volatiles is thus observed by reducing the amount of styrene present in the formulation by only 40 weight percent.

### Example 3

Common odor tests, such as VDA 270, use a numerical scale to classify odor of materials in vehicle interiors. Such as grading system uses a scale like the one below:

| | |
|---|---|
| Grade 1 | Not perceptible |
| Grade 2 | Perceptible, not disturbing |
| Grade 3 | Clearly perceptible, but not |
| | disturbing |
| Grade 4 | Disturbing |
| Grade 5 | Strongly disturbing |
| Grade 6 | Not acceptable |

Several SMC formulations were compounded with alternative monomers for odor evaluation. All formulations with alternative monomers were observed by volunteers to have a less offensive odor (Grades 1-3) than a conventional SMC formulated with only styrene as the reactive diluent (Grades 4-6). In some cases where alternative monomers were used the odor was deemed imperceptible by the volunteer, Grade 1.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A low profile additive composition comprising:
a plurality of thermoplastic particles; and
a hydrogen bonding monomer in which said plurality of thermoplastic particles are dispersed and forming hydrogen bonding with said plurality of thermoplastic particles, said hydrogen bonding monomer having at least two of: a boiling point of greater than 210° C., a viscosity of less 140 cps at 25° C., or vapor pressure lower than 5 mm Hg at 20° C.

2. The low profile additive composition of claim 1 further comprising a styrenic monomer displaced by said hydrogen bonding monomer.

3. The low profile additive composition of claim 1 wherein said composition has an odor test grade of 1-3 as measured by standardized VDA 270 odor test method.

4. The low profile additive composition of claim 1 wherein said plurality of thermoplastic particles comprise a hydrogen bonding thermoplastic of at least one of polyacrylates, phenolic resin, pheoxy resin, poly(vinylphenol), polyamide, polyethylene glycol, polymethylmethacrylate, polyvinylacetate, polycarbonate, or combinations thereof; and copolymers including butadiene, acrylonitrile, and vinyl chloride and specifically include styrene butadiene rubbers, or combinations thereof.

5. The low profile additive composition of claim 4 wherein said hydrogen bonding thermoplastic is at least 10 percent by weight of said plurality of thermoplastic particles.

6. A cured article comprising:
a cured matrix formed by polyurethane or polyurea polymerized with a styrenic monomer; and
the low profile additive composition of claim 1 wherein the article has a volatile amount of styrenic monomer of less than 40 parts per million (ppm) as measured by standardized VDA 278 test method.

7. The article of claim 6 wherein said styrenic monomer is styrene present in an at less than 10 ppm.

8. The article of claim 6 further comprising a thickener, said thickener being an alkaline earth oxide, an alkaline earth hydroxide, or a combination thereof.

9. The article of claim 6 further comprising a coating applied to a surface of the article, said coating being free of blisters visible to an unaided, normal human eye.

10. The article of claim 6 further comprising a fiber reinforcement.

11. The article of claim 6 wherein the article has a shape of a bumper beams, a fender, a vehicle door panel component, an automotive floor component, a spoiler, a hood, or an engine cradle.

12. The article of claim 6 wherein the article has an odor test grade of 1-3 as measured by standardized VDA 270 odor test method.

13. A method of forming a low VOC low profile additive composition comprising:
exposing a low profile additive composition comprising a plurality of thermoplastic particles dispersed in a styrenic monomer to a hydrogen bonding monomer in which said plurality of thermoplastic particles are dispersed and forming hydrogen bonding with said plurality of thermoplastic particles, said hydrogen bonding monomer having at least two of: a boiling point of greater than 210° C., a viscosity of less 140 cps at 25° C., or vapor pressure lower than 5 mm Hg at 20° C.; and
allowing sufficient time for said hydrogen bonding monomer to displace said styrenic monomer from contact with said plurality of thermoplastic particles to form the low VOC low profile additive composition.

14. The method of claim 13 further comprising dialyzing said styrenic monomer from the low VOC low profile additive composition.

15. The method of claim 13 wherein said styrenic monomer is styrene.
